(19) United States
(12) Patent Application Publication
(10) Pub. No.: US 2017/0368890 A1
(43) Pub. Date: Dec. 28, 2017

(54) TIRE MONITOR

(71) Applicant: Ford Global Technologies, LLC, Dearborn, MI (US)

(72) Inventors: Jorge Manuel Rodriguez Vazquez, Atizapan de Zaragoza (MX); Jonatan Leff Yaffe, Mexico City (MX); Carlos Emilio Merino, Benito Juarez (MX); Luis Manuel Garcia, Mexico City (MX)

(21) Appl. No.: 15/192,563

(22) Filed: Jun. 24, 2016

(51) Int. Cl. B60C 11/24; B60R 25/30; B60R 25/34; G01M 17/02

(52) U.S. Cl. CPC B60C 11/246; G01M 17/027; B60R 25/307; B60R 25/34

(57) ABSTRACT

A vehicle includes: a tire monitor, located in a wheel arch and configured to: project beam(s) onto a tire, measure reflection(s) of the beam(s); memory, processor(s) configured to, based on the reflection(s): build a two-dimensional (2D) profile of the tire, compare depths of the built profile to depths of a preloaded profile, assess tire wear based on the comparison.

### TECHNICAL FIELD

This disclosure relates to measuring or approximating tire wear.

### BACKGROUND

U.S. Pat. No. 8,625,105 to Pryce discloses an apparatus that measures the tread of a tire on a vehicle, in which a laser line generator generates an elongate pattern of light. Mirrors are arranged to reflect light from the laser line generator onto the rolling surface of the tire. Mirrors are arranged to reflect light from different regions of the rolling surface of the tire towards a camera. The camera images the regions of the rolling surface of the tire. The apparatus may be hand-held or arranged such that a tire to be aged is driven onto or over it.

U.S. Publication No. 2015/0330773 to Uffenkamp discloses a device for measuring the tread depth of a tire including measuring modules situated transversely with respect to the running direction of the tire and connected to a shared evaluation device. Each measuring module includes (i) an illumination device which is configured and situated in such a way that during operation it projects at least one light line onto the tread to be measured, and (ii) at least one image recording device recording at least one image of at least one area of the tread to be measured. The at least one illumination device and the at least one image recording device are configured and situated in such a way that the illumination direction of the illumination device and the image recording direction of the image recording device are oriented neither in parallel to one another nor orthogonally with respect to the tread.

U.S. Pat. No. 6,069,966 to Jones discloses a method and apparatus for automotive tire condition and other article assessment based upon radiation analysis of a rotated tire. Analysis of reflected radiation on the basis of intensity sensing provides a measure of tread depth and sidewall profile, together with tread location and other data. By positional analysis of the tread depth locations there is provided complementary information on the tread wear pattern. Sidewall profile determination enables identification of other tire condition factors. Tread depth and sidewall profile are also determined by laser or other radiation line image displacement techniques and a mounting system is provided for the apparatus enabling determinations to be made without the use of a roller bed. Proper positional alignment of the wheel to the apparatus is determined by means of a reference datum derived from reflected radiation within the apparatus. Proper defined proximity of the tire is defined by a pair of alignment bars positioned over an optical window of the apparatus.

U.S. Pat. No. 7,538,864 to Golab discloses a vehicle wheel alignment sensor for a machine-vision vehicle wheel alignment system comprising a scanned beam camera incorporating an illumination source, a means for deflecting light emitted by the illumination source along a path within a field of view, and a detector array for receiving illumination reflected from objects within the field of view to generate an image which is representative of a region of interest within the field of view.

### SUMMARY

In various embodiments, the present disclosure includes a vehicle having: a tire monitor, located in a wheel arch and configured to: project beam(s) onto a tire, measure reflection(s) of the beam(s); memory, processor(s) configured to, based on the reflection(s): build a two-dimensional (2D) profile of the tire, compare depths of the built profile to depths of a preloaded profile, assess tire wear based on the comparison.

In various embodiments, the present disclosure includes a method of monitoring a tire with a vehicle including a tire monitor located in a wheel arch, memory, and processor(s), the method comprising: with the tire monitor: projecting beam(s) onto a tire, measuring reflection(s) of the beams; with the processor(s) and based on the reflection(s): building a two-dimensional (2D) profile of the tire, comparing depths of the built profile to depths of a preloaded profile, assessing tire wear based on the comparison.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram of a vehicle computing system.

FIG. 2 is a top view of a vehicle including the vehicle computing system.

FIG. 3a is a top view of a tire.

FIG. 3b is a two-dimensional profile of the tire taken across segment 303 of FIG. 3a.

FIG. 4 is a side view of the vehicle including a tire monitor.

FIG. 5 is a three-dimensional lookup table.

FIG. 6 is a block diagram of a turning routine.

FIG. 7 is a block diagram of a search routine.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”.

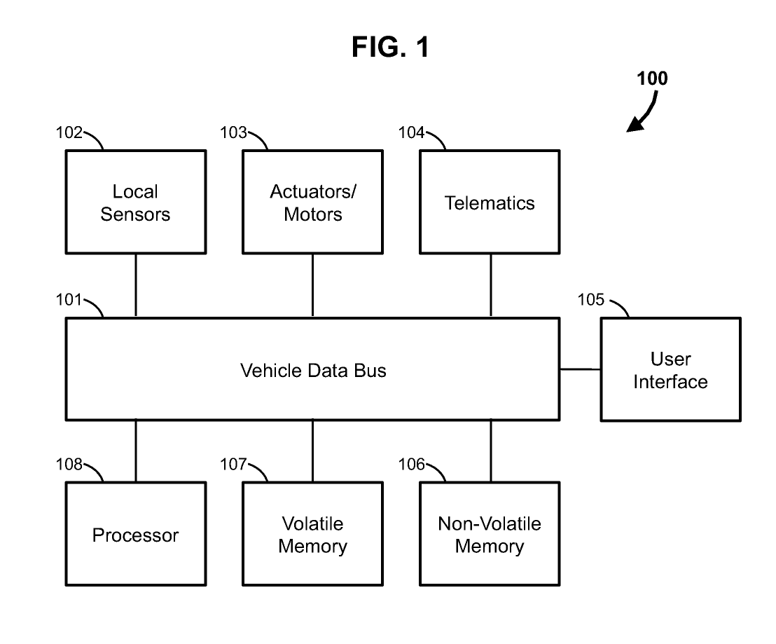

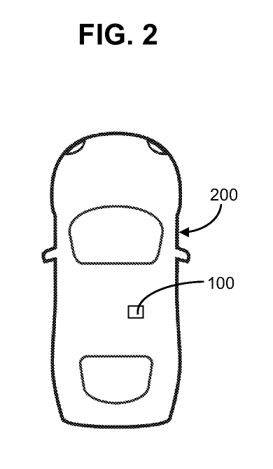

FIG. 1 shows a computing system 100 of an example vehicle 200. The vehicle 200 includes a motor, a battery, at least one wheel driven by the motor, and a steering system configured to turn the at least one wheel about an axis. Suitable vehicles are also described, for example, in U.S. patent application Ser. No. 14/991,496 to Miller et al. (“Miller”) and U.S. Pat. No. 8,180,547 to Prasad et al. (“Prasad”), both of which are hereby incorporated by reference in their entirety. In various embodiments, the vehicle 200 includes four wheels, each wheel having a corresponding tire 300.

The computing system 100 enables automatic control of mechanical systems within the device. It also enables communication with external devices. The computing system 100 includes a data bus 101, one or more processors 108, volatile memory 107, non-volatile memory 106, user interfaces 105, a telematics unit 104, actuators and motors 103, and local sensors 102.

The data bus 101 traffics electronic signals or data between the electronic components. The processor 108 performs operations on the electronic signals or data to produce modified electronic signals or data. The volatile memory 107 stores data for immediate recall by the processor 108. The non-volatile memory 106 stores data for recall to the volatile memory 107 and/or the processor 108. The non-volatile memory 106 includes a range of non-volatile memories including hard drives, SSDs, DVDs, Blu-Rays, etc. The user interface 105 includes displays, touch-screen displays, keyboards, buttons, and other devices that enable user interaction with the computing system. The telematics unit 104 enables both wired and wireless communication with external processors via Bluetooth, cellular data (e.g., 3G, LTE), USB, etc. The actuators/motors 103 produce physical results. Examples of actuators/motors include fuel injectors, windshield wipers, brake light circuits, transmissions, airbags, the steering, etc. The local sensors 102 transmit digital readings or measurements to the processor 108. Examples of suitable sensors include temperature sensors, rotation sensors, seatbelt sensors, speed sensors, cameras, lidar sensors, radar sensors, the disclosed tire monitor(s), etc. It should be appreciated that the various connected components of FIG. 1 may include separate or dedicated processors and memory. Further detail of the structure and operations of the computing system 100 is described, for example, in Miller and/or Prasad.

It should be appreciated that the vehicle 200 is configured to perform the methods and operations described below. In some cases, the vehicle 200 is configured to perform these functions via computer programs, such as a tire monitoring program, stored on the various volatile or non-volatile memories of the computing system 100. In other words, a processor is configured to perform a disclosed operation when it is in operative communication with memory storing a software program with code or instructions embodying the disclosed operation. Further description of how the processor, memories, and programs cooperate appears in Prasad. It should further be appreciated that a nomadic device, such as a mobile phone, in operative communication with the vehicle 200 may alternatively or in addition perform some or all of the methods and operations discussed below by querying the sensors of the vehicle 200.

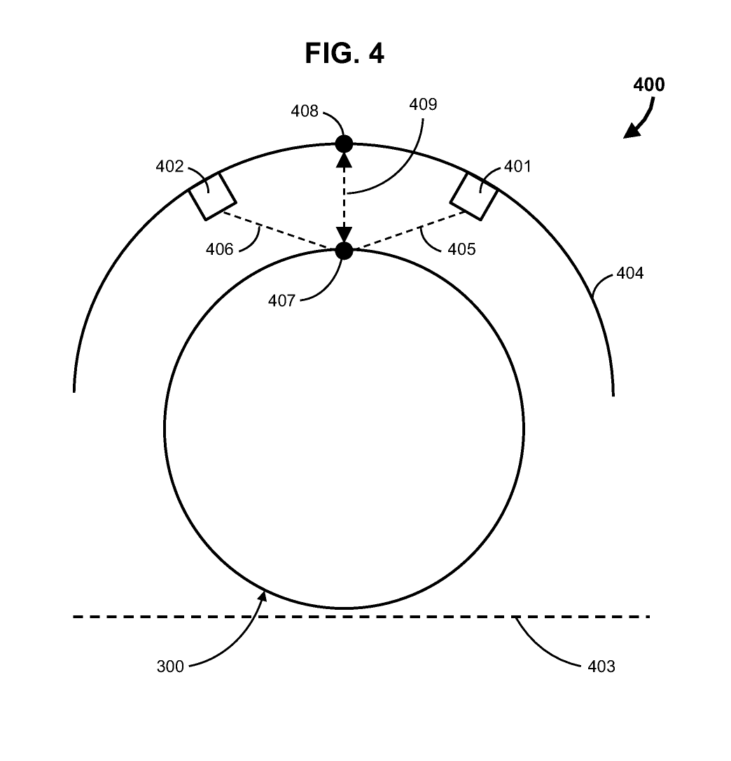

FIG. 4 generally shows and illustrates a tire monitor 400 consistent with the present disclosure. The tire monitor 400, in conjunction with the tire monitoring program stored on the memory 106, 107 and/or executed on the processor 108, is configured to: (a) monitor tire treads, (b) monitor ride height, and (c) confirm presence of the tire. The tire monitor 400 includes beam emitter(s) 401 and beam receiver(s) 402. As shown in FIG. 4, the tire monitor 400 is fixed underneath a wheel arch 404 of the vehicle 200 and is configured to scan or monitor a tire 300 of the vehicle 200 as the vehicle 200 travels along a road 403. It should be appreciated that the vehicle 200 may include one tire monitor 400 in each wheel arch 404. In various embodiments, to save cost, the vehicle 200 includes a single tire monitor 400. The data from the single tire monitor 400 serves as a representative sample for all tires of the vehicle 200. In various embodiments, to save cost, the vehicle 200 includes a single tire monitor 400 per axle.

With reference to FIG. 4, the beam emitter(s) (also referred to as emitter(s)) 401 project beam(s) of light 405, some of which reflect off the tire along incident segment 407. The incident segment 407 of FIG. 4 extends into the page along a width dimension of the tire 300. The incident segment 407 is approximately straight, but may include some bends due to the depths of tire grooves 302. The reflected beam(s) 406 proceed to beam receiver(s) (also referred as receiver(s)) 402. It should be appreciated that other optical devices (e.g., cameras) may be used instead of emitter(s) and receiver(s). It should be appreciated that emitter and receiver technology is known in the art and is regularly applied in dimensioning depths of tire treads and tire grooves. In various embodiments, the tire monitor 400 includes a range-finder 408, also located under the wheel arch 404, configured to measure the vertical distance or range 409 between the tire 300 and the wheel arch 404. Range-finders 408 are commercially available and are known in the art. Some range-finders determine range by projecting and receiving beam(s) of light.

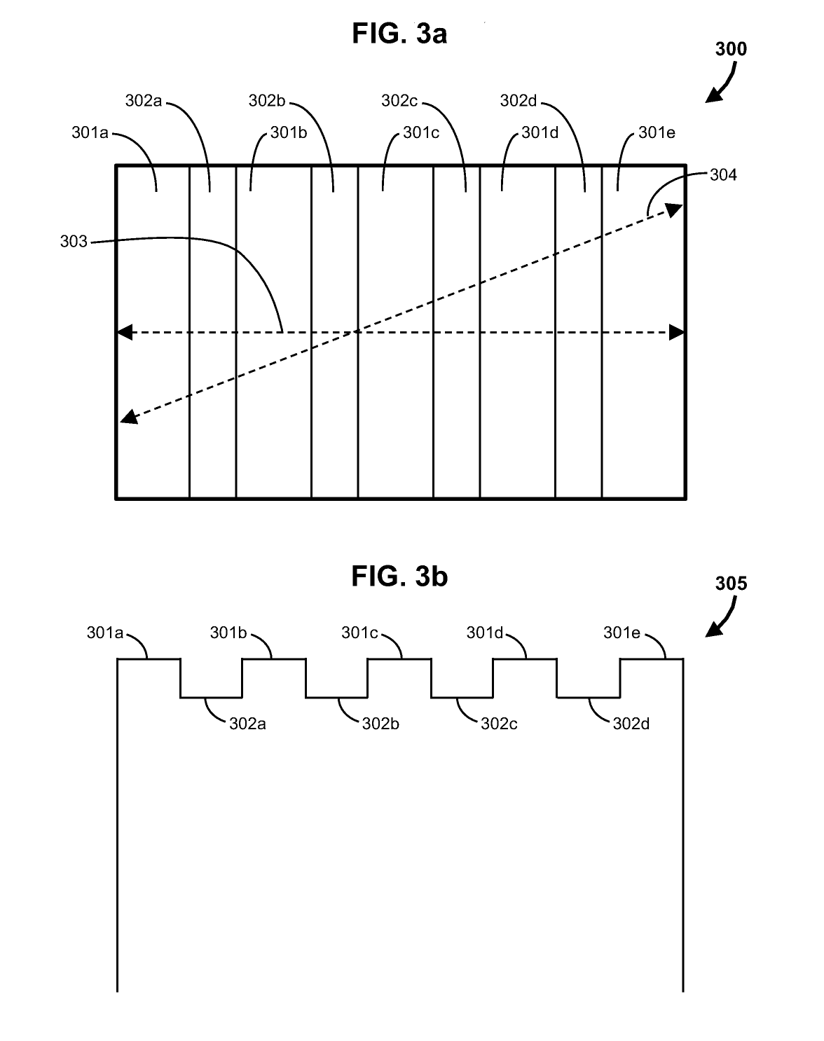

FIG. 3a generally shows and illustrates top view of the tire 300. The tire 300 includes treads 301a, 301b, 301c, 301d, and 301e. The tire defines grooves 302a, 302b, 302c, and 302d between the treads 301. The tire 300 of FIG. 3a is an example and it should be appreciated that the disclosed systems and methods may be applied to any suitable tire with a pattern of treads 301 and grooves 302.

The tire monitoring program applies data reported from the tire monitor 400 to measure or dimension the a two-dimensional profile 305 of the top of the tire 300 along profile segment 303. More specifically, the tire monitoring program is configured to apply data generated by the receiver(s) 402 and the range finder 408 to map or profile a depth of the treads 301 and the grooves 302 along profile segment 303. In various embodiments, the receiver(s) and the range finder 409 report a magnitude and/or an angle of the reflected beam(s) 406 to the processors 108 and/or the memory 106, 107. The tire monitoring program applies software to convert one or more of the reported magnitude(s), the angle(s), and the range 409 into the two-dimensional profile 305. In various embodiments, the software adjusts the depths associated with the tire treads 301 and grooves 302 according to the range 409 reported by the range finder 408. In various embodiments, the total width of the projected beam(s) 405 exceeds a total width of the tire 300 by a predetermined amount (e.g., 10%, 20%, or 30%) so that the incident segment 407 can span across and cover an entire width of the tire 300, even when the tire 300 is turned or angled.

FIG. 3b shows a generated two-dimensional profile 305. The top vertical profile 305 includes heights or depths of the treads 301 and/or the grooves 302 extending in a direction parallel to depth 409 and perpendicular to profile segment 303. The two-dimensional profile 305 generated by the tire monitor program includes widths extending in a direction parallel to profile segment 303. More specifically, and as shown in FIG. 3b, each of the treads 301 and the grooves 302 has a width. The tire monitoring program is configured to group recorded depths into a series of widths. For example, the tire monitoring program may begin from the left side of the tire 300 and group all vertical dimensions falling within a predetermined percentage (e.g., 5% or 10%) of each other into a first width, corresponding to tread 301a. The tire monitoring program may then recognize depths falling outside of the predetermined percentage. The tire monitoring program may now group all vertical dimensions falling within a predetermined percentage of each other into second width, corresponding to groove 302a. The tire monitoring program may repeat this process until all treads 301 and all grooves 302 have been mapped or profiled (and thus generating a complete two-dimensional profile 305), such that each tread 301 has a depth and a width and each groove 302 has a depth and a width. It should be appreciated that for the purposes of this disclosure, the terms depth, height and vertical distance are synonymous (unless context indicates otherwise) as applied to the tire treads and the tire grooves. These vertical measurements may be relative to each other, relative to a baseline, or relative to the wheel arch 404.

Under ideal conditions, the incident segment 407 will be perpendicular to the radius of the tire 300. Vehicle wheels (and thus tires) turn during steering. Tire turn will cause the incident segment 407 to skew (i.e., angle) with respect to the radius of the tire 300. As shown in FIG. 3, skew may result in an improper profile segment 304. Skew will degrade the quality and reliability of the two-dimensional profile 305.

In various embodiments, the tire monitoring program compares the determined widths of the treads 301 and/or the grooves 302 to preloaded widths of a preloaded or manufacturer-specified two-dimensional profile 305. When the determined widths match the preloaded widths within predetermined boundaries, then the tire monitoring program confirms that the tire 300 is straight and the incident segment 407 is perpendicular to the radius of the tire 300. In other words, the tire monitoring program is configured to discard measurements that generate groove and treads widths that mismatch the preloaded widths. In various embodiments, tire turn will cause corrupt or extraordinary (i.e., nonsensical) measurements. These corrupt or extraordinary measurements will also be discarded. As explained below, it should be appreciated that discarded measurements/profiles may first be referenced by the search algorithm before being discarded (e.g., to confirm that a new measurement is an improvement over a previous mismatched/corrupted measurement).

FIG. 3a shows an example skewed profile segment 304 resulting from a skewed incident segment 407. Because the incident segment 407 is skewed, the widths of each treads 301 and grooves 302 may be expanded (i.e., too wide). After generating a two-dimensional profile 305 corresponding to the skewed profile segment 304, the tire monitoring program may compare the determined widths of treads 301 and grooves 302 to the preloaded widths. Under this scenario, because the determined widths will exceed the preloaded widths, the tire monitoring program will eventually discard the two-dimensional profile 305 corresponding to the skewed profile segment 304. It should be appreciated that a comparison of each tread 301 and/or groove 302 is unnecessary and that the comparison can be performed with reference to a width of a single tread 301 (e.g., tread 301) and/or a width of a single groove (e.g., groove 302c). In various embodiments, the tire monitoring program compares the width of each tread 301 and/or groove 302 to the preloaded widths, and confirms the tire 300 as straight when a predetermined confirmation number (e.g., one, two, etc.) of widths match the preloaded widths. The term “match” as used in the specification and claims encompasses matching within certain predetermined boundaries or limits, e.g., the measured value is within 1%, 5%, etc. of the expected value.

In various embodiments, the wheel monitor program is configured to, upon user selection and/or a schedule and/or detecting park, perform a turning routine to turn the wheels (and thus the tires 300) until the determined widths match the preloaded widths. Because each of the wheels may be permanently offset with respect to the other wheels, the wheel monitor program may execute this process once for each wheel. For example, the wheel monitor program may begin with the front left wheel and turn the wheel until the determined widths of the front left tire 300 match the preloaded widths. Once this occurs, the wheel monitor program saves the two-dimensional profile 305 of the front left tire 300 having the matching widths and turns to another wheel, such as the front right wheel. The wheel monitor program repeats the process with respect to the front right tire 300. In various embodiments, the wheel monitor program is configured to only enable performance of the turning routine when the vehicle is detected to be in park.

As stated above, the turning routine involves turning the wheels until the determined widths of a tire 300 match the preloaded widths. In various embodiments, the turning routine proceeds as follows: First the turning routine compares the determined widths to the preloaded widths. If the determined widths fail to match the preloaded widths, then the turning routine causes the vehicle 200 to turn the wheel in a first direction. The turning routine then compares newly determined widths to the previously determined widths. If the newly determined widths are closer to the preloaded widths than the previously determined widths, then the turning routine continues turning the wheel in the first direction. The turning routine continues turning the wheel until the determined widths match the preloaded widths.

If, however, the newly determined widths exceed the previously determined widths or a corrupt or extraordinary result is returned, then the turning routine causes the vehicle 200 to turn the wheel in a second, opposing direction. The turning routine causes the vehicle 200 to turn the wheels in the second direction until the determined widths match the preloaded widths. It should thus be appreciated that the turning routine may perform a search algorithm that compares one or more of newly determined widths, previously determined widths, and preloaded widths until the newly determined widths match the preloaded widths.

As stated above, the turning routine does not need to compare the width of each tread 301 and groove to each preloaded width. Instead, the turning routine can select representative a width of treads 301 (e.g., tread 301c) and/or a representative width of grooves (e.g., groove 302c). If a two-dimensional profile 305 generated according to the turning routine is extraordinary (e.g., fails to contain any treads 301 or grooves 302), then the turning routine may turn the tire 300 until the determined two-dimensional profile 305 sufficiently corresponds to the preloaded two-dimensional profile, and then execute the above search.

Eventually, the wheel monitor program generates a suitable two-dimensional profile 305 with widths matching the preloaded widths of the preloaded two-dimensional profile 305. The wheel monitor program now compares the vertical dimensions of the suitable two-dimensional 305 against preloaded vertical dimensions of the preloaded two-dimensional profile 305.

As the tire 300 contacts the road 403, friction will erode the treads 301, reducing the vertical height of the treads 301 with respect to the grooves 302. Additionally, objects may become embedded in the threads 301 and/or the grooves. These embedded objects will increase/obscure/corrupt a vertical dimension along profile segment 303. For example, an embedded object may reflect projected beam 405 backward, away from receiver 402, thus causing a gap or absence of information for one or more of the treads 301 and the grooves 302.

The tire monitoring program thus compares a determined depth or vertical dimension (e.g., height) of each tread 301 to one or more preloaded depths or vertical dimensions of each tread 301. When the vertical dimension of a tread 301 and/or a groove 302 exceeds an upper preloaded vertical dimension by a predetermined degree, then the tire monitoring program marks the tread and/or groove as damaged with an embedded object. When the vertical dimension of a tread 301 and/or a groove 302 is less than a lower preloaded vertical dimension by a predetermined degree, then the tire monitoring program marks the tread as being worn. When the vertical dimension of a tread 301 and/or a groove 302 cannot be determined, then the monitoring program marks the tread and/or the groove as unknown. The tire monitoring program is configured to display the status of each tread and/or groove 302. When the vertical dimensions of a predetermined wear number of treads and/or grooves are worn and/or unknown, the monitoring program instructs the vehicle 200 to issue an alert or trigger a vehicle alarm. The alert may be an electronic message sent over the telematics 104 to the mobile device.

It should be appreciated that various factors such as load on the tire, tire temperature, and tire pressure influence the vertical and/or horizontal dimensions of the treads 301 and the grooves 302. In various embodiments, the monitoring program selects the preloaded two-dimensional profile 305 from a set of preloaded two-dimensional profiles.

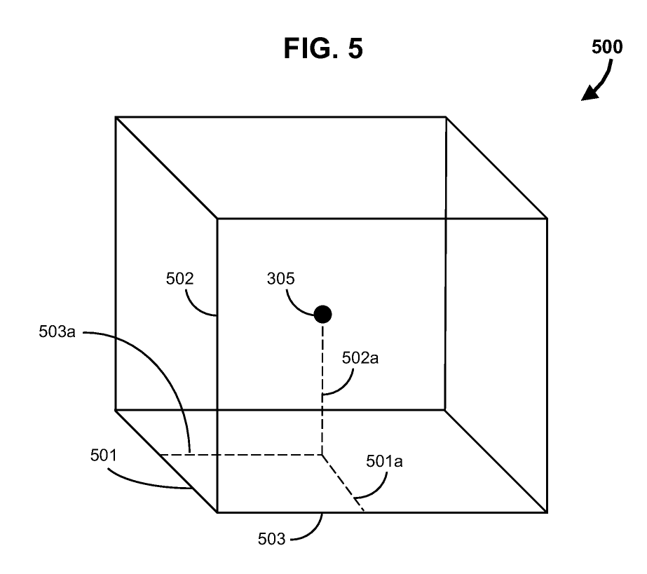

FIG. 5 represents the set of two-dimensional profiles assembled into a cube 500. The cube 500 includes many pre-loaded two-dimensional profiles 305. Each preloaded two-dimensional profile 305 has an X coordinate 503a, a Y coordinate 501a, and a Z coordinate 502a. To select a preloaded two-dimensional profile 305, the monitoring program must determine proper coordinates 503a, 501a, and 502a respectively along the X axis 503, the Y axis 501, and the Z axis 502. Each axis 501, 502, and 503 corresponds to a different factor. For example, the X axis 503 may correspond to tire temperature, the Y axis 501 may correspond to tire pressure, and the Z axis 502 may correspond to load on the tire 300.

The cube 500 may be loaded based on a model number of the tire. For example, the non-volatile memory 106 may store one cube 500 for each acceptable tire 300. When a new tire 300 is installed on the vehicle, the user may input the model of the tire 300 into the monitoring program (e.g., via the user interface 105) and the monitoring program may select a cube 500. The monitoring program continues to reference the selected cube 500 until the user specifies a newly installed tire 300.

The tire monitoring program may receive information from the local vehicle sensors 102 to select the proper X, Y, and Z coordinates 503a, 501a, and 502a. For example, as the tire temperature changes, the tire monitoring program may adjust the X coordinate 503a. As the tire pressure changes, the tire monitoring program may adjust the Y coordinate 501a. As the load or weight on the tire changes, the tire monitoring program may adjust the Z coordinate 502a. Digital tire load sensors, tire temperature sensors, and tire pressure sensors are individually known in the art. In various embodiments, the range 409 measured by the range-finder 408 is used to approximate tire load. Once the tire monitoring program has selected the proper X, Y, and Z coordinates 503a, 501a, and 502a, the tire monitoring program selects a corresponding preloaded two-dimensional profile 305.

Moisture may impair or obscure dimensions measured by the wheel monitor 400. In various embodiments, the wheel monitor 400 includes a moisture sensor mounted to the underside of the wheel arch 404. The monitoring program may discard two-dimensional profiles 305 (or decline to generate the two-dimensional profiles 305) when the moisture sensor senses a certain level of moisture.

As stated above, the vehicle 200 applies the tire monitor 400 to confirm the presence of a tire. More specifically, the range finder 408 periodically measures the range 409 when the vehicle is in park. When the range increases by more than a predetermined degree (e.g., by more than 20%), the tire monitoring program assumes that the tire 300 is absent. The tire monitoring program now instructs the vehicle 200 to issue an alert or trigger a vehicle alarm. The alert may be an electronic message sent over the telematics 104 to the mobile device.

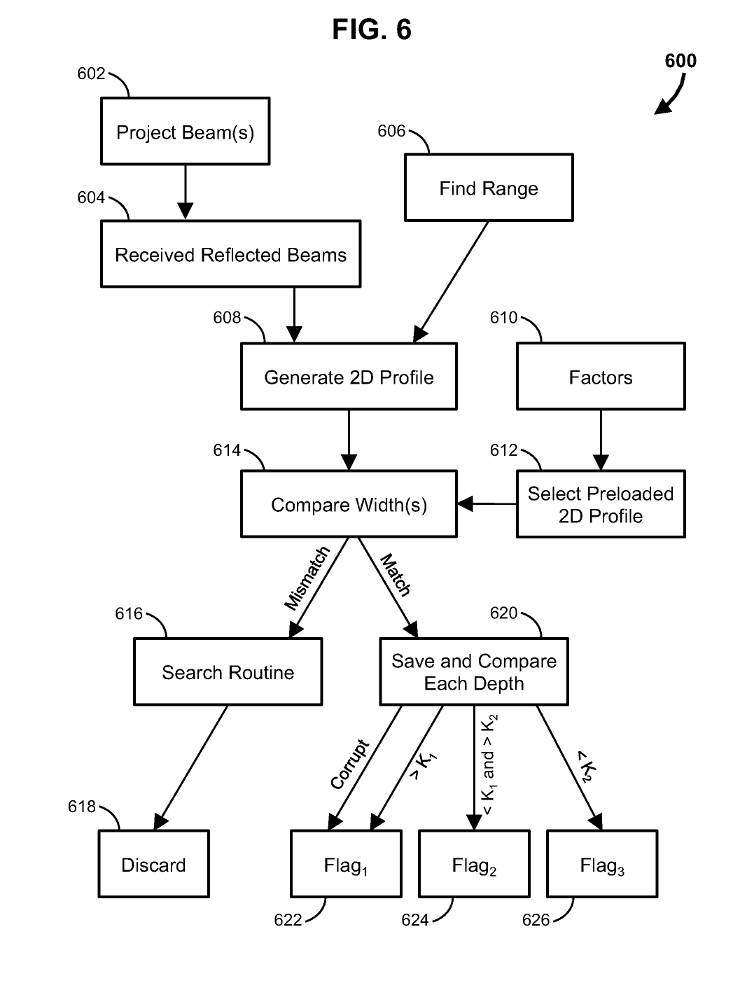

FIG. 6 generally shows and illustrates an example turning routine 600 executed by the wheel monitoring program. In various embodiments, the wheel monitoring program only executes the turning routine 600 when the vehicle has been in park for at least a predetermined amount of time. In various embodiments, the wheel monitoring program only executes the turning routine 600 within a certain time window (e.g., a schedule set by the user via the user interface 105). At block 602, the tire monitor 400 projects the beam(s) 405. At block 604, the tire monitor 400 receives the reflected beam(s) 406. Simultaneously with one or more of blocks 602 and 604, the tire monitor 400 finds the range 409 at block 606.

The tire monitor program collects data generated by the tire monitor 400 and builds a two-dimensional profile 305 at block 608. At block 610, the tire monitor program loads factors (e.g., tire load, tire temperature, tire pressure, etc). At block 612, the tire monitor program selects a preloaded two-dimensional profile 305 via the cube 500. At block 614, the tire monitor program compares the determined width(s) of the treads 301 and/or the grooves 302 to the preloaded width(s).

If block 614 results in a match, then the tire monitor program saves the two-dimensional profile 305 and compares each depth of the measured two-dimensional profile 305 to the preloaded two-dimensional profile 305. If a depth is corrupt (e.g., extraordinary) or above a first constant, K1, then the tire monitor program assigns a first flag, flag1, to the groove/tread at block 622. If the depth is normal, or between the first constant and a second constant, K2, then the tire monitor program assigns a second flag, flag2, to the groove/tread at block 624. If the depth is worn or less than the second constant K2, then the tire monitor program assigns a third flag to the groove/tread at block 626.

The various flags cause the tire monitor programs to display different alerts via the user interface 105. For example, the first and third flags may cause the tire monitor program to automatically issue an unprompted alert via the user interface 105. It should be appreciated that each constant is derived from and associated with the preloaded two-dimensional profile 305 and may change depending on the specific tread and/or groove (e.g., tread 301c may have different constants than tread 301d).

If block 614 results in a mismatch or a corrupt result, then the tire monitor program executes the search routine at block 616. After performing the search routine, the tire monitor program discards the mismatched or corrupt two-dimensional profile 305.

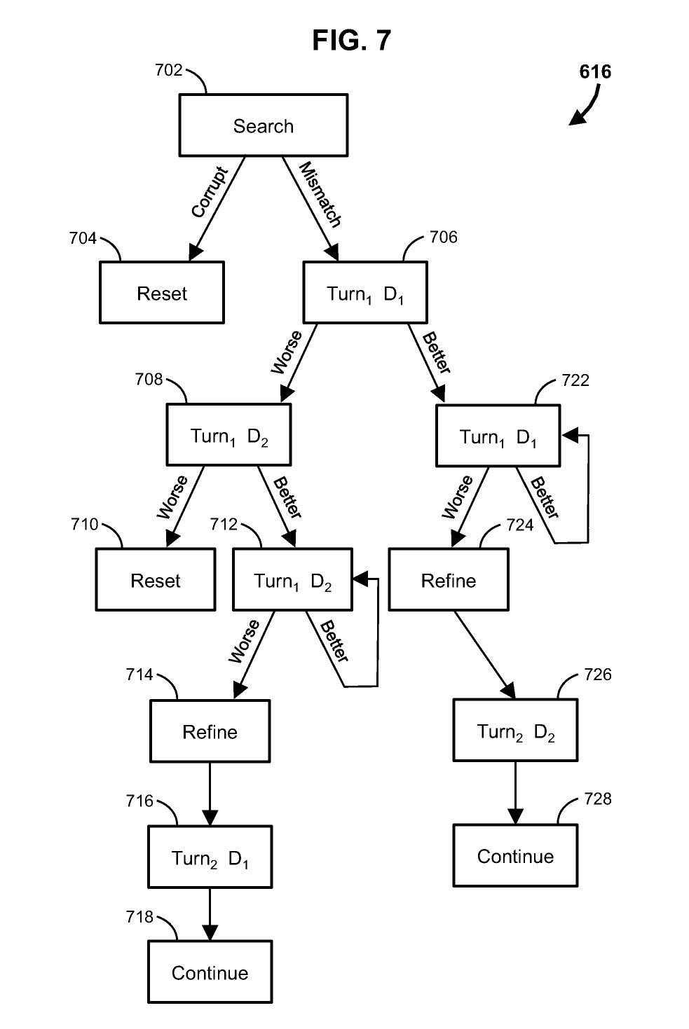

FIG. 7 generally shows and illustrates an example search routine 616. At block 702, the tire monitor program 400 determines whether block 614 returned a mismatch or a corrupt result. A mismatch is a result that resembles the correct result within coarse limits or boundaries (e.g., the widths are 20% wider than expected). A corrupt result is a nonsensical or extraordinary result (e.g., only a single width is found when the tire has 10 treads and 9 grooves).

If the result is corrupt, the search routine 616 proceeds to block 704 where the orientation of the tire 300 is reset to a first orientation. If the result is a mismatch, then the routine proceeds to block 706 where the wheel is turned a first degree, Turn 1, in a first direction, D1. At block 706, the routine repeats steps 602, 604, 606, 608, and 614 (collectively referred to as “the comparison”). It should be appreciated that the search routine 616 performs the comparison at each block of FIG. 7 associated with a turn and a direction.

At block 706, if the new profile 305 better matches the preloaded profile 305 than the previous profile 305, then the search routine proceeds to block 722. If the new profile 305 more poorly matches the preloaded profile 305 than the previous profile 305, then the search routine proceeds to block 708. It should generally be appreciated that the search routine 616 ends when one of the comparisons is a match. It should generally be appreciated that each previous profile 305 is discarded at block 618 after the previous profile 305 has been used in the comparison.

At block 722, the search routine 616 turns tire the first degree in the first direction and executes the comparison. If the comparison is better, then the search routine 616 continues executing block 722 until the comparison yields a worse result (i.e., a new profile 305 more poorly matches the preloaded profile 305 than the previous profile 305).

When the comparison becomes worse, the search routine 616 refines the search at block 724. More specifically, the search routine causes the wheel to turn a second degree, Turn 2, in a second direction, D2. The second direction is opposite the first direction. After block 726, the search routine 616 performs the comparison. Block 728 shows that the search routine 616 continues until a newly measured profile 305 matches the preloaded profile 305. The search routine 616 may continue in block 728 by executing the refining process associated with blocks 722 and 724 for block 726 (i.e., repeating block 726 until a worse profile 305 is measured, and then refining the search by turning a third degree, Turn 3, in the first direction, D1, the third degree being less than the second amount).

At block 708, the search routine 616 causes the wheel to turn the first degree, D1, in the second direction, D2. If the new profile 305 is worse, then the search routine 616 causes the tire to reset at block 710. The reset of block 710 may be a reset to a different position than the reset of block 704. A reset at block 710 may cause the search routine 616 to end and issue a corresponding warning via the user interface 105.

If the new profile 305 is better, then the search routine proceeds to block 712. The above disclosure related to blocks 722, 724, 726, and 728 applies to blocks 712, 714, 716, and 718.

1. A vehicle comprising:
a tire monitor, located in a wheel arch and configured to: project beam(s) onto a tire, measure reflection(s) of the beam(s);
memory, processor(s) configured to, based on the reflection(s): build a two-dimensional (2D) profile of the tire, compare depths of the built profile to depths of a preloaded profile, assess tire wear based on the comparison.

2. The vehicle of claim 1, wherein the processor(s) are configured to:
activate a vehicle theft alarm based on the reflection(s), or lack thereof.

3. The vehicle of claim 2, wherein the processor(s) are configured to: determine a ride height of the vehicle based on the reflection(s).

4. The vehicle of claim 1, wherein the processor(s) are configured to: determine whether the built profile matches the preloaded profile before performing the comparison.

5. The vehicle of claim 4, wherein the processor(s) are configured to: determine the match by comparing width(s) of the built profile against width(s) of the preloaded profile.

6. The vehicle of claim 5, wherein the processor(s) are configured to: only determine the match by comparing the width(s) of the built profile against the width(s) of the preloaded profile.

7. The vehicle of claim 6, wherein the width(s) extend in a direction perpendicular to a radius of the tire.

8. The vehicle of claim 1, wherein the processor(s) are configured to: run a tire monitoring program that builds the two-dimensional (2D) profile of the tire, compares the built profile to the preloaded profile, and assesses the tire wear based on the comparison.

9. The vehicle of claim 8, wherein the processor(s) are configured to: run the tire monitoring program based on a set schedule.

10. The vehicle of claim 1, wherein the processor(s) are configured to: select the preloaded profile based on tire pressure, tire temperature, and tire load.

11. The vehicle of claim 1, wherein the processor(s) are configured to: execute a search routine based on the comparison.

12. The vehicle of claim 11, wherein the processor(s) are configured to: rotate the tire in opposing directions as part of the search routine.

13. The vehicle of claim 1, wherein the tire monitor includes a moisture sensor and the processor(s) are configured to: abstain from building the 2D profile when a sensed moisture level exceeds a predetermined moisture level.

14. A method of monitoring a tire with a vehicle including a tire monitor located in a wheel arch, memory, and processor(s), the method comprising:
with the tire monitor: projecting beam(s) onto a tire, measuring reflection(s) of the beams;
with the processor(s) and based on the reflection(s): building a two-dimensional (2D) profile of the tire, comparing depths of the built profile to depths of a preloaded profile, assessing tire wear based on the comparison.

15. The method of claim 14, comprising:
activating a vehicle theft alarm based on the reflection(s) or lack thereof.

16. The method of claim 15, comprising: determining a ride height of the vehicle based on the reflection(s).

17. The method of claim 14, comprising: determining whether the built profile matches the preloaded profile before performing the comparison.

18. The method of claim 17, comprising: determining the match by comparing width(s) of the built profile against width(s) of the preloaded profile.

19. The method of claim 18, comprising: only determining the match by comparing the width(s) of the built profile against the width(s) of the preloaded profile.

20. The method of claim 19, wherein the width(s) extend in a direction perpendicular to a radius of the tire.
